(19) United States
(12) Patent Application Publication
(10) Pub. No.: US 2004/0104174 A1
(43) Pub. Date: Jun. 3, 2004

(54) Chromatographic separation process

(76) Inventors: Henry S. Kolesinski, Naples, FL (US); Jonathan N. Kremsky, Arlington, MA (US)

Correspondence Address: Gaetano D. Maccarone, Esq., 63 Chelsea Street, Charlestown, MA, 02129, US

(21) Appl. No.: 10/721,132

(22) Filed: Nov. 25, 2003

Related U.S. Application Data
(60) Provisional application No. 60/429,228, filed on Nov. 26, 2002.

(51) Int. Cl. B01D 15/08

(52) U.S. Cl. 210/656; 435/6; 210/631

(57) ABSTRACT

There are described processes for the separation of components from a fermentation product or other biomass product. The fluid mixture is passed through a separation column having at least one capture element having flow channels of about 50 μ or greater and which includes chemically active capture material capable of capturing a desired component from the mixture. The separation column may include a plurality of the chemically active capture elements.

### REFERENCE TO RELATED APPLICATIONS

This application claims the benefit of provisional application serial No. 60/429,228, filed Nov. 26, 2002.

Reference is made to commonly-assigned application, Ser. No. ______ filed on even date herewith (Attorney Docket No. HK001AFP), the entire disclosure of which is hereby incorporated by reference herein.

### FIELD OF THE INVENTION

This application relates to high throughput processes for separating substances chromatographically and, more particularly, to such processes in which fermentation products and other biomass products are passed through a capture element having flow channels of about 50μ or greater.

### BACKGROUND OF THE INVENTION

The continuing surge in the development of biotechnology products and processes has brought with it the need for efficient and cost effective separation and purification processes and apparatus. The preparation of new drugs via recombinant DNA/fermentation continues to expand with the introduction of new candidates on a regular basis. The preparation of new drugs by fermentation processes can be divided into two general categories which are typically generally referred to as “upstream” and “downstream” processes. The upstream processes address the biochemical design of the system to produce the desired biopharmaceutical product and the downstream processes focus on harvesting and purifying the final product.

Downstream processing involves the following functions: a) cell disruption, if necessary, to free the contents of the fermentation cells; b) centrifugation to provide clarification of the contents by separating the cell debris from the mother liquor containing the desired product and other biological entities; c) ultrafiltration to concentrate the mother liquor for subsequent steps; and d) final product purification, typically by liquid chromatographic techniques using multi-method separation methods, e.g., ion exchange, hydrophobic interaction, reverse phase, chiral, etc. These batch processes are time consuming and expensive to practice, typically requiring large amounts of elution solvents. It is estimated that about 70-80% of the cost of preparing drugs is associated with the separation and purification of such products.

As the state of the art in the separation and collection of desired products from fermentation products advances and efforts are made to eliminate or at least reduce the disadvantageous characteristics of the present techniques, there is a continuing need for improved separation processes and apparatus.

### SUMMARY OF THE INVENTION

It is therefore an object of this invention to provide novel processes for the separation of desired products, or components, from fermentation products or other biomass products.

It is another object to provide such processes wherein separation of mixtures of components in fluids can be carried out on a continuous basis.

It is still another object to provide such processes for the separation of mixtures of biological components in fluids.

It is a further object to provide such processes for the removal and partial purification of small- and macromolecules which are produced by the fermentation of microbial cells.

Yet another object is to provide such processes which are useful in the process scale purification of products produced by chemical synthesis.

These and other objects and advantages are attained in accordance with the present invention by providing processes for separating desired products from fermentation products or other biomass products. In one aspect of the invention there is provided a separation process wherein a fermentation product is passed through a column having one or more capture, or collection, elements which have flow channels of about 50μ or greater, preferably 75μ or greater and, particularly preferably, about 100μ or greater. Each capture element contains chemically active capture material adapted to capture a specific desired component from the mixture. The chemically active capture materials can be provided by treating the surface of the capture element with suitable chemicals such as functional polymer coatings or by chemical derivatization of the support materials. The capture elements allow unwanted components of the fermentation products, such as cell debris, to flow through and simultaneously capture a desired product by specific chemical interaction with the chemically active capture material. Thus, lysed fermentation broth can be injected directly onto the column containing the capture element(s) and the desired product captured and removed.

According to one embodiment of the process of the invention, the fermentation product or other biomass product can be passed through a plurality of such capture elements which have the same chemical activity so the same product is captured by each capture element.

The separation column which is used to carry out the process of the invention can also include a sample loading module, or unit, which is in fluid communication with a separation module of the column. In this embodiment the sample loading module serves as a reservoir for the initial fluid mixture and does not contain any capture material. Fluid flow into the separation module can be initiated by various means including applying a vacuum to the column.

Any suitable separation chemistry may be utilized in accordance with the invention. Typical suitable separation chemistries which may be utilized in the processes of the invention include reverse phase, ion exchange, hydrophobic interaction, affinity, etc,

The processes of the invention replace two batch processes, and the separate apparatus required to carry out these batch processes, associated with the current downstream processing of biologically prepared pharmaceutical products, i.e., centrifugation and ultrafiltration, with a single continuous process and one separation column. Further, the lysing of microbial cells may be performed just prior to injection of the mixture onto the separation column including the capture element(s) thus incorporating three batch processes, i.e., cell lysing, centrifugation and ultrafiltration, into one continuous process. Various methods may be utilized for cell disruption and lysis. One such method involves the addition of a surfactant to a fermentation broth while other methods rely on physical techniques such as high shear mixers, sonification and high impact fluidized mixers. Carrying out cell lysis prior to injection of a fermentation broth onto the separation apparatus can eliminate some of the product stability problems typically associated with batch cell lysis thus improving yields and purity of the final product.

### DESCRIPTION OF THE PREFERRED EMBODIMENTS

As described above, the separation processes of the invention are carried out with a separation column having one or more individual separation elements which have flow channels of about 50μ or greater, preferably about 75μ or greater and, particularly preferably 100μ or greater. Each capture element contains chemically active capture material. The capture elements are preferably rigid.

The porous capture elements may be of any suitable materials including metals, such as, for example sintered stainless steel, metal oxides such as, for example, silicon oxide and aluminum oxide, inorganic materials, organic materials, ceramic materials, hybrids and the like. The porous capture elements have a specific capture chemistry which may be provided by treating the surface of the capture material with a specific chemical such as a suitable polymer coating or by chemical derivatization of the capture material. Any suitable separation chemistry may be utilized in accordance with the invention such as, for example, reverse phase, ion exchange, hydrophobic interaction, affinity, etc. Preferably, affinity chemistry is desirable since there is provided a chemical specificity for the desired product. Where an affinity support is utilized, the entire separation column is utilized for the capture of the desired product and unwanted materials such as cell debris are allowed to flow through the column to be collected as waste or recycled where appropriate. Ion exchange chromatography is a particularly preferred capture and purification mechanism for biological molecules and distribution of products.

Some collection plate materials may be chromatographically active without any functional treatment. There are many commercially available chemically active sheet membranes which are suitable for use according to the invention.

The porosity of the capture elements utilized according to the invention is generally suitable to allow the fermentation products and other biomass products to pass through. Many such capture elements are commercially available. An example of such a capture element is an approximately 0.93 inch thick sheet of sintered stainless steel having flow channels of about 50μ which is available from Mott Corporation, Farmington, Conn.

In a preferred embodiment of the invention, by utilizing chemically modified capture element having the specified porosity, i.e., plates having flow channels of about 50μ or greater, direct injection of a lysed fermentation broth into the column where one or more of the capture elements is present will permit the flow through of cell debris to waste, with the option for subsequent capture and reuse, and the simultaneous capture of the desired product by specific interaction with the capture element surface chemistry.

Any number of capture elements may be used in a separation column Generally, the size of the capture elements and the number of capture elements in any separation column are determined by the volume of fluid to be injected into the column, e.g., the volume of the fermentation batch, the capture efficiency of the capture material and the fluid dynamics of the system.

The separation column into which the volume of fluid containing the mixture of components is injected may include an initial member with capture elements having specific capture chemistry directed to the removal of interfering undesired materials such as nucleic acids in lysates. The desired product in the fluid can then be bound in one or more capture elements of the separation column employing similar but different capture chemistry.

The fermentation product to be separated may be injected into the separation column under pressure due to the pumping of the mobile phase, i.e., the flow rate of the fluid, and possible back pressure, if any. High or low pressure may be used.

The separation column may be held at any temperature and may be heated or cooled as required.

The chromatographic separation processes of the invention may be utilized in the chromatographic separation processes and apparatus described and claimed in co-pending, commonly assigned U.S. patent application Ser. No. ______, filed on even date herewith (Attorney Docket No. HK001AFP), the entire disclosure of which is hereby incorporated by reference herein.

### EXAMPLES

The invention will now be described further in detail with respect to specific preferred embodiments by way of examples, it being understood that these are intended to be illustrative only and not limiting of the scope of the invention. Various changes and modifications to the disclosed embodiments will be apparent to those skilled in the art. Such changes and modifications, including without limitation, those relating to the materials, process parameters, and/or methods of the invention may be made without departing from the spirit of the invention and the scope of the appended claims. All parts and percentages recited are by weight unless otherwise specified.

### Example I

This example describes the synthesis of a strongly cationic capture material, a copolymer of pyridinium ylide and sulfopropyl methacrylate, potassium salt.

A 1 L round bottom flask was equipped with a stir bar, an ice bath, an addition funnel, and a nitrogen source. The flask was charged with 25 gms of 1-aminopyridinium iodide (Aldrich Chemical) in 150 mL of tetrahydrofuran, and the N₂-flushed flask cooled to 10° C. To the flask was added a solution of 17.5 grams of 2-isocyanatoethylmethacrylate (Aldrich Chemical) dissolved in 75 mL tetrahydrofuran, dropwise over 20 minutes. The mixture was allowed to warm to room temperature and stirred overnight. The solvent was removed in vacuo and the residue triturated with hexane to afford pyridinium, 1-[[[[2-[(2-methyl-1-oxo-2-propenyl)oxy]ethyl]aminocarbonyl]amino]hydroxide, inner salt.

A 500 mL three-necked round bottom flask was equipped with a magnetic stirrer, a stir bar, a source of dry nitrogen, a thermometer, and a heating mantle. The flask was charged with 4.98 gms of the monomer described above and 19.68 grams 2-methacrylic acid 3-propanesulfonic acid, potassium salt (Aldrich Chemical). These were then dissolved by the addition of 225 mL water. This mixture was then treated with 72 mg 2, 2′-azobisisobutyronitrile (Alfa Aesar). The flask was flushed with nitrogen, and the flask sealed with rubber septa. The mixture was heated to 65° C. for 20 hours. The solution was cooled to room temperature and the polymer product isolated by precipitation into 2 L acetone. The isolated solid can be hardened by repeated triturations with acetone. Finally, the material was dried in vacuo to afford the copolymer.

### Example II

This example describes the preparation of a column containing capture elements according to the invention

Initially, 30 mm diameter discs were cut from an approximately 0.93 inch thick sheet of sintered stainless steel having flow channels of about 50μ (Mott Corporation, Farmington, Conn.). The discs were tared and soaked with methylene chloride while being sonicated. After a few minutes the discs were removed from the sonicator, the methylene chloride replaced and the process repeated one additional time. The discs were dried in vacuo and re-weighed.

The strongly-cationic copolymeric capture material of Example I was dissolved in water to provide a 15% solution (w/w). The tared discs were then added to the copolymer solution to allow the capture material to adhere to the discs after which they were removed, blotted on a paper towel and placed in an oven at 125° C. for ten minutes. The discs were then removed from the oven, cooled to room temperature, weighed and the process then repeated. Following drying to constant weight each disc was found to have approximately 50 mg of the copolymer adhered thereto.

Sixteen of the stainless steel discs were stacked, one on top of the other, into a steel column which was lined with an approximately 0.4 mm latex sheet to ensure that subsequent flow of fluid would be through the discs and not down the sides of the column. The column was then washed with gradients of 50 mM of pH 4 sodium phosphate buffer (buffer A) and then with the same solution containing 1M sodium chloride buffer (buffer B). The column was equilibrated with buffer A at 5 mL/minute. The back pressure was approximately 400 pounds per inch² psi).

### Example III

This example describes the capture of a protein using rigid capture elements according to the invention.

The column was attached to a Hitachi Model D-7000 HPLC System equipped with a Model L-7400 variable wavelength UV detector, Model L-7400 pump and a Model L-7500 autoinjector. Data was collected using a Hitachi HSM Data System.

The column was loaded by repeated injections of bovine serum albumin (BSA) at a concentration of 5 mg/mL in buffer A and the effluent monitored at 254 nm. The injections were repeated until breakthrough was achieved, that is, the discs bound the BSA until they were completely saturated and the excess washed through. The column was then washed with buffer A until a stable baseline was obtained, as indicated by monitoring at 254 nm.

The captured BSA was then eluted from the discs with 100% buffer B and the total 254 nm-absorbing peak collected. The protein content was measured by comparison with a standard BSA curve and found to be 30 mg in a total peak volume of 97 mL.

### Example IV

The experiment described in Example III was repeated using 50 mL BSA at a concentration of 5 mg/mL spiked into a yeast cell lysate.

A total of 50 mL lysate was loaded onto the column under the same conditions described in Example III. After processing as described, a total of 38 mg total protein was eluted from the column in 105 mL of buffer B.

It was observed that as the BSA spiked yeast cell lysate was loaded onto the column the initial effluent was quite turbid since the cell debris was pushed through the column. No increase in back pressure was noted during the entire capture and collection steps. Flow rates of up to 50 mL were possible on the column although the dynamic capacity of the column was not determined.

The results show that the cell debris flowed through the capture elements, i.e., the discs, without constraint and the protein was captured and subsequently collected effectively.

Although the invention has been described in detail with respect to various preferred embodiments, it will be understood that these are intended to be illustrative only and the invention is not limited thereto, but rather that those skilled in the art will recognize that variations and modifications may be made therein which are within the spirit of the invention and the scope of the appended claims.

What is claimed is:

1. A chromatographic separation process comprising passing a biomass product through a separation column having at least one chemically active capture element having flow channels of 50μ or greater, whereby at least a portion of a desired component of said fermentation product is captured by said capture element.

2. The chromatographic separation process as defined in claim 1 wherein said biomass product comprises a fermentation broth which includes components which are the products of recombinant DNA processes.

3. The chromatographic separation process as defined in claim 1 wherein said separation column includes a plurality of said capture elements, whereby each said capture element captures a portion of the same component of said mixture.

4. The chromatographic separation process as defined in claim 1 wherein said capture element has flow channels of about 75μ or greater.

5. The chromatographic separation process as defined in claim 1 wherein said capture element has flow channels of about 100μ or greater.

6. The chromatographic separation process as defined in claim 1 wherein said capture element is sintered steel.
